(19) United States
(12) Patent Application Publication
(10) Pub. No.: US 2002/0062306 A1
(43) Pub. Date: May 23, 2002

(54) Systems and methods for controlling network communications

(75) Inventors: Joseph P. Perrone, Chicago, IL (US); Nathan P. Taubitz, Chicago, IL (US)

Correspondence Address: Patrick G. Burns, GREER, BURNS & CRAIN, LTD., Suite 2500, 300 South Wacker Drive, Chicago, IL, 60606, US

(73) Assignee: UTT Corporation, Inc., d/b/a Withit

(21) Appl. No.: 09/989,216

(22) Filed: Nov. 20, 2001

Related U.S. Application Data
(60) Provisional application No. 60/252,450, filed on Nov. 21, 2000.

(51) Int. Cl. G06F 7/00

(52) U.S. Cl. 707/1

(57) ABSTRACT

A data communication system has a network and an originating domain or host through which stored or live content can be requested. Access criteria for retrieving the content through a content distribution facility is specified by an originating domain administrator. Authorized users can satisfy the access criteria, and unauthorized users cannot. The originating domain provides the authorized user with a link to requested content in a content distribution facility. Access to the content is controlled by allowing the authorized user to present to the content distribution facility the specified content request and the address of the specified originating domain network location. The authorized user retrieves the content through the content distribution facility only after properly presenting correct access criteria.

This is a continuation of provisional application Serial No. 60/252,450, filed Nov. 21, 2000.

### FIELD OF THE INVENTION

This invention relates to systems and methods for controlling network communications, and more particularly, to systems and methods that control access to particular content on a network.

### BACKGROUND OF THE INVENTION

Modern Internet communications allow a plurality of users to access multiple websites, or domains. A variety of information can be stored at the site and accessed, including multimedia content. In addition, one user can contact another user and refer the second user to a website address, through a link. The second user can then access the website directly, using the link provided by the first user.

Some domains have secured content such as confidential financial data, provide content based upon viewship or ratings, and the like, and websites have difficulty preventing an unauthorized user from obtaining the secure content intended to come from its original host or source location when the link to the secured content is forwarded by an authorized user who has the specific query train or syntax link to the secured or nested content. Known security systems address this problem by adding multiple layers of security such as additional log-ins or user inputs, which slows the system and ease of use as well as system performance. Thus, there is a need for improved systems and methods that maintain security of secured information on networks, even when a link is provided or is passed to unauthorized users.

Content providers sometimes provide unique or specially prepared content for affiliates, syndicates, service providers, such as America Online, etc. Such content is only intended to be seen by users of those affiliates, etc., even though the content provider might have other content available on an unrestricted basis. However, such unique content can sometimes be viewed by nonusers of the affiliates, etc., when the links or URL's for the related content are forwarded by a user of the affiliates, etc. Thus, there is also a need to control or channel access to website links to limit the use of predetermined content to users of particular content providers or hosts.

Accordingly, one object of this invention is to provide new and improved systems and methods for controlling network communications.

Another object is to provide new and improved systems and methods that control access to particular content on a network, particularly when links to content are passed from an authorized user to an unauthorized user.

Yet another object is to provide new and improved systems and methods that limit the use of predetermined content to users of particular affiliates, syndicates, service providers, and other content providers.

### SUMMARY OF THE INVENTION

A data communication system has a network and an originating domain or host through which stored or live media or content can be requested and retrieved. Access criteria for retrieving the content through a content distribution facility is specified by an originating domain administrator. Authorized users can satisfy the access criteria, and unauthorized users cannot. The originating domain provides the authorized user with a link to the content in the content distribution facility. Access to the content is controlled by allowing the authorized user to present to the content distribution facility the specified content request and the address of the specified originating domain content network location. The authorized user retrieves the content through the content distribution facility only after properly presenting successful access criteria.

### BRIEF DESCRIPTION OF THE DRAWINGS

FIG. 1 is a block diagram of a data communication system made in accordance with the present invention;

FIG. 2 is a flow chart of the request redirection process;

FIG. 3 is a flow chart of the operation of the content requestor process; and

FIG. 4 is a flow chart for analyzing user and content access criteria.

### DETAILED DESCRIPTION

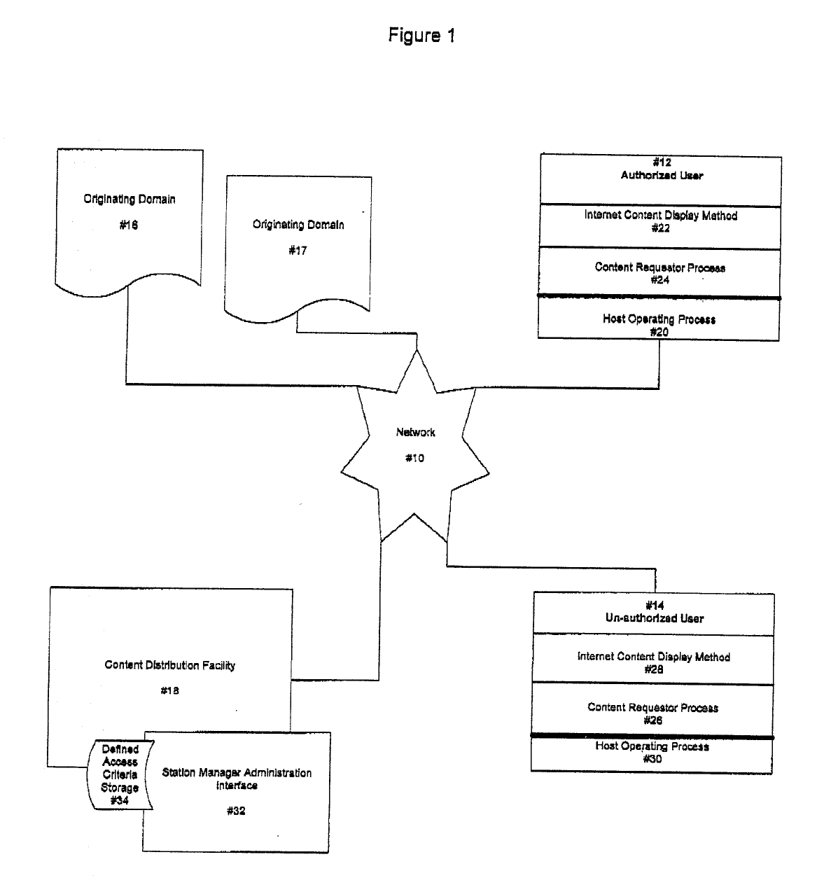

As seen in FIG. 1, a data communication system includes a network 10 such as the worldwide web, known as the Internet, an intranet, which could be established within a company or the like, or any other network. A plurality of users 12, 14, have access to the network, and a plurality of sites or domains 16, 17, 18, provide media or content. In FIG. 1, the domains 16 and 17 provide content directly or through other domains, and could be websites operated by the National Broadcasting Company (NBC®), its affiliates, syndicates, American On Line (AOL®), etc. The domain 18 is a content distribution facility that can be used by the domains 16, 17, as will be described.

In a typical system, the users 12, 14 have a device containing operating operating codes such as a host operating process 20, e.g., Microsoft Windows, Linux, or the like, and an Internet content display method 22, such as a browser. The browser allows the user 12 to access the domain 16, for example, and obtain content, which can be live or stored. The content provider 16 responds to a request for content with a text or binary file, described appropriately by a MIME tag, that typically includes a referring address or a URL link that redirects the user to the content. The file also typically includes information about the content which is typically stored or available through some content distribution facility 18. Thus, the file tells the requesting computer, i.e., the user, what type of content is being sent, so that the user's device can locate the content and render it properly.

The content distribution facility 18 can be located at a different site from the originating domain 16, or it can be contained within the domain or host process 16. In addition, the content distribution facility 18 can be one or more than one physical facility, and could include sites or facilities around the world.

The user 12 also has a browser-based multimedia player or content requestor process 24, which is typically software codes or the like having the ability to interpret encoded messages from originating domains, as well as viewing media as will be described. The user 14 also has a content requestor process 26, which in FIG. 1 is configured to interpret requests in a different manner than the content requestor process 24. The user 14 also has an Internet content display method 28 and a host operating process 30. The differences between the content requestor processes 24, 26 cause the user 12 to be an authorized user in the examples that follow, and cause the user 14 to be an unauthorized user in those examples.

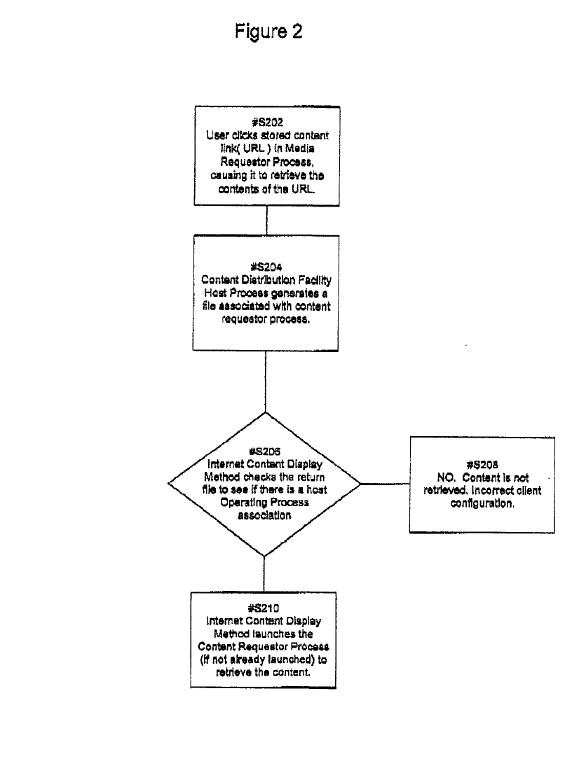

The manner in which requests from the authorized user 12 are redirected from the originating domains 16 or 17 to the content distribution facility 18 is described in more detail in FIG. 2. At S202, the user sends a media link (URL) over the network, causing the user's device to retrieve the content to which the URL refers. At S204, the originating domain generates a file (associated with the media requestor process on the local host operating process) which includes all information needed to retrieve the requested media. As an additional measure to certify the request as authentic, a key based security communication could be included. At S206, the user checks the file received from the originating domain 16 for a user program association, through the content requester process 24. If there is no association, i.e., if the content requestor cannot interpret the redirection request, access to the content is denied at S208. If there is an association, i.e., the content requestor interprets the request and presents it to the facility 18 in an expected form, then the Internet content display system 22 accesses the link in the content distribution facility 18 at S210.

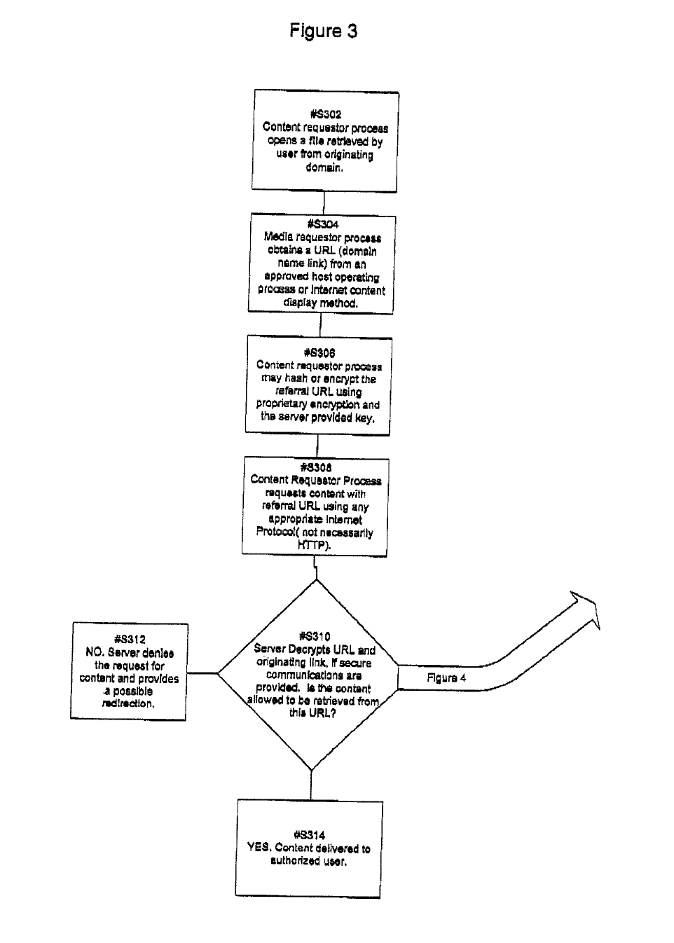

The operation of the content requestor process 24 is shown in greater detail in FIG. 3. At S302, the media requestor process 24 opens a requested file retrieved by the authorized user 12. At S304, the content requestor process 24 obtains an address (a URL or domain name link) from the host operating process 20 or Internet content display method 22. At S306, the content requestor process 24 may hash or encrypt the URL using a key-based encryption method, if desired. SHA1 is one example of such a key-based security method.

At S308, the content media requester process 24 requests the desired content using a referral URL with any appropriate Internet protocol, such as HTTP or any other suitable network protocol. At S310, the content distribution facility 18 decrypts the URL (if encrypted) received from the user, and determines whether the content can be retrieved from that source. If not, access is denied at S312. If the required access criteria is met, the content stream is delivered to the user at S314.

The invention has application in several situations. For example, a domain (content provider) that provides public information, such as NBC®, may want certain content to only be accessed through a particular provider such as AOL®. In this example, NBC® is the referral domain, and AOL® is a referrer domain because AOL® refers its users to the designated content at the NBC® domain site. Applying this example to FIG. 1, the originating domain 16, such as NBC®, could provide public information and it might provide some content to be accessed only through the originating domain 17 (AOL®). In that event, the access criteria required by the content distribution facility 18 would include the location of the originating domain 17 (AOL®), as well as the originating domain 16 (NBC®). Thus, if an unauthorized user tried to directly access the NBC® content through the originating domain 16 (NBC®), access would be denied because the location of the originating domain 17 (AOL®) would be missing.

As another example, the NBC® site could have both publicly available, unsecured information, and other information that is secured or controlled. In that event, NBC® would be considered a host. This configuration could be used, for example, if a national NBC® site, which developed national news, provided content to its affiliates in various cities throughout the country. Certain local news could be controlled so that a user could only reach that news through the website of a particular local NBC® affiliate. Conversely, the local affiliate would be required to link and be granted access to the national news on the NBC® corporate website. In that event, the local site would be the originating domain 17, and it would link to the originating domain 16, which would be the national news website of NBC®.

In this manner, the originating domain 17 can syndicate the content of the originating domain 16, which means that domain 17 is merely linking to portions of the content in domain 16. The defined access criteria 34 of the domain 16 should include the location of domain 17, or a sub-domain of domain 17.

As still another example, a site having confidential information could secure it using this invention. In that event, also, the site would be considered a host. Applying this example to FIG. 1, the originating domain 16 would have both publicly available, unsecured information, and secured information. If the user 12 requests the secured content, originating domain 16 would send a link to the user 12, which would not be understood by the Internet content display method 20. The host operating process 22 would search for a program that understood the link, and would find it in the content requested process 24. The user 12 would then direct that request to the content distribution facility 18, where the user would be recognized as an authorized user. In this example, the access criteria includes the content URL from the originating domain link, which is sent with the location of the user 12 to the facility 18.

The originating domain system administrator decides whether authorization should be based on the referrer domain or the host through a station manager administration interface 32. The system administrator can also decide whether access should be granted based on a list of authorized hosts or users, or a list of unauthorized hosts or users. These decisions are stored in a multimedia database or the Defined Access Criteria Storage mechanism 34, and establish the access criteria used to identify authorized and/or unauthorized users of particular content.

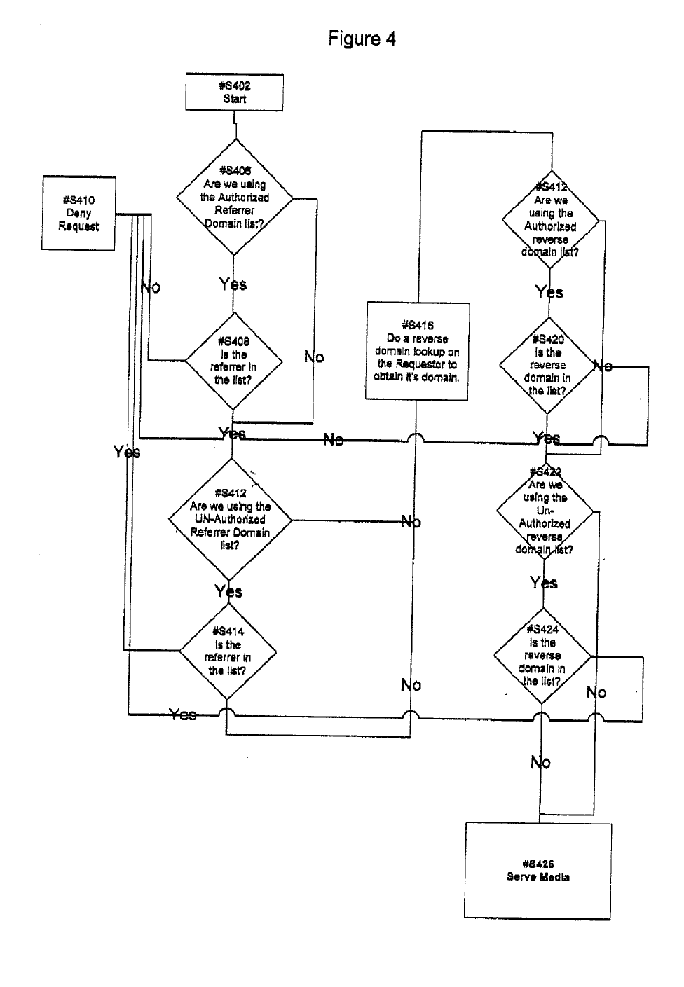

When a request is received in the content distribution facility 18, the content distribution facility 18 determines the parameters or criteria set by the administrator for access, and determines whether access is authorized according to the access criteria. Referring to FIG. 4, the content distribution facility 18 starts the decision making process at S402. The system determines whether the administrator wants access to be allowed based on an authorized referrer domain list at S406. The referrer domain list could be used for syndication, for example, and primarily determine if the domain or URL location of the specific content item from the user matches a location on the list. If the list at S406 is used, the system determines whether the referrer domain is in the list at S408. If not, the request is denied at S410. If the referrer domain is found on the list at S408, or if the administrator decided that an authorized referrer domain list is not to be used as access criteria for that content, then the system determines whether the administrator decided to use an authorized referrer domain list as access criteria at S412. If so, it is determined whether the referrer domain or network address is on the list at S414. If the referrer domain or network is on the list of unauthorized users, then the request is denied at step S410. If not, or if the unauthorized referrer domain list is not being used, the system proceeds to step S416, which refers to a reverse domain look up.

A reverse domain look up identifies the requesting user's domain or network by translating a network number to a network domain or network name. This could be used in the example above in which the NBC® content administrator limits access of some content to the AOL® network or domain.

If the administrator decided that an authorized reverse domain list should be used at S418, it is determined whether the domain is in the reverse domain list at S420. If not, the request is denied at S41 0. If so, or if the authorized reverse domain list is not used, the system determines whether it is to use an unauthorized reverse domain list at S422. If so, it is determined whether the requestor is on the reverse domain list at S424. If so, the request is denied. If not, or if the unauthorized reverse domain list is not being used, the request is granted at S426.

The user 12 is an authorized user because it has the ability to decode a unique file, described appropriately by its MIME type, that is provided for secured information. The software, firmware or the like is specially provided to authorized users. The software decodes the unique file, which includes the name and network location of the domain 18, and sends the request, which includes the domain 16, any related subdomains, and the source URL link of domain 16, to the domain 18. The domain 18 then sends the requested content to the user 12.

The user 14 is an unauthorized user, and does not have the ability that is provided to user 12. In this case, if the user 14 requests content from the domain 16, and the Internet content display method 28 of user 14 passes the unique file to the operating system, the operating system, or method codes of user 14 will not understand the file because it does not have the software, firmware or the like, and the user 14 will not be able to access the content 18.

In use, the station manager administrator sets the access criteria for particular content, as desired. As the originating domain 16 develops new content, the content is uploaded to the content distribution facility 18. Authorized users are provided with an appropriate content request or process 24, which interprets referral files returned from the originating domain 16 when the content is requested by the user. By referring requests into a hosted element, the content distribution facility 18, content cannot be easily passed to unauthorized users by forwarding links. The user 12 can use an ordinary security method that may be already pre-existing between the user 12 and the originating domain 16, such as a typical log-in procedure. Through the referral to the content distribution facility 18, the user 12 presents the original source material and how it found the original source material from the originating domain 16, such that when properly presented to the content distribution facility 18, the request for content is granted. Without going through the referral process, though, the request is denied. In this manner, there are no additional log-in or security methods burdened on the user. Also, the originating domain content owner maintains control over access to the content.

The many advantages of this invention are now apparent. Unauthorized use of links, including a mass emailing of URLs pointing to multimedia content, and the unauthorized use of specialized Internet programming, is substantially prevented. Servers are not as likely to be overwhelmed with streaming media requests from unauthorized viewers, in the media or content as only viewed by its intended audience. Thus, this invention provides a value added service to content providers and allows them to develop rich multimedia content to a specified group, which cannot be easily tampered with or devalued in its presentation.

While the principles of the invention have been described above in connection with specific apparatus and applications, it is to be understood that this description is made only by way of example and not as a limitation on the scope of the invention.

What is claimed is:

1. In a data communication system having a network, at least one originating domain through which content can be requested, a content distribution facility through which the content can be accessed according to defined access criteria, the access criteria including a location of the originating domain, a location of the content distribution facility, and a location of the requested content, at least one authorized user having means for satisfying the access criteria, and at least one unauthorized user that can not satisfy the access criteria, a method for controlling access to the content comprising the steps of:
a selected user requesting selected content through the originating domain, the originating domain providing the selected user with a referral to the content distribution facility,
the selected user requesting the selected content from the content distribution facility using the referral and the access criteria,
the content distribution facility verifying whether the access criteria are present to determine whether the selected user is authorized or unauthorized, and
allowing the selected user, if authorized, to retrieve the selected content through the content distribution facility.

2. The method of claim 1, wherein the access criteria includes a password that may be used by one or more of the authorized users.

3. The method of claim 1, wherein the access criteria includes a location of a second originating domain.

4. The method of claim 1, wherein the content is stored in memory.

5. The method of claim 1, wherein the content is live information.

6. The method of claim 1, wherein the access criteria is defined by a station manager administration interface.

7. The method of claim 6, wherein the access criteria includes a list of authorized referral domains.

8. The method of claim 6, wherein the access criteria includes a list of unauthorized referral domains.

9. The method of claim 6, wherein the access criteria includes a list of authorized source reverse domains.

10. The method of claim 6, wherein the access criteria includes a list of unauthorized reverse source domains.

11. The method of claim 6, wherein the access criteria can include a sub-domain of the root domain.

12. The method of claim 12, wherein the content is requested or exchanged through a secured link, the secured link having an encrypted session via key exchange.

13. The method of claim 1, wherein the location is an Internet link.

14. The method of claim 1, wherein the referral includes a MIME tag.

15. A data communication system comprising
a network,
at least one originating domain through which content can be requested,
a content distribution facility through which the content can be accessed according to defined access criteria, the access criteria including a location of the originating domain, a location of the content distribution facility, and a location of the requested content,
at least one authorized user having means for satisfying the access criteria, and at least one unauthorized user that can not satisfy the access criteria,
wherein a selected user requests selected content through the originating domain, the originating domain providing the selected user with a referral to the content distribution facility,
the selected user requests the selected content from the content distribution facility using the referral and the access criteria,
the content distribution facility verifies whether the access criteria are present to determine whether the selected user is authorized or unauthorized, and the selected user, if authorized, is allowed to retrieve the selected content through the content distribution facility.

16. The system of claim 15, wherein the access criteria includes a password that may be used by one or more of the authorized users.

17. The system of claim 15, wherein the access criteria includes a location of second originating domain.

18. The system of claim 15, wherein the content is stored in memory.

19. The system of claim 15, wherein the content is live information.

20. The system of claim 15, wherein the access criteria is defined by a station manager administration interface.

21. The system of claim 20, wherein the access criteria includes a list of authorized referral domains.

22. The system of claim 20, wherein the access criteria includes a list of unauthorized referral domains.

23. The system of claim 20, wherein the access criteria includes a list of authorized source reverse domains.

24. The system of claim 20, wherein the access criteria includes a list of unauthorized source reverse domains.

25. The system of claim 20, wherein the access criteria can include a sub-domain of the root domain.

26. The system of claim 15, wherein the content is requested or exchanged through a secured link, the secured link having an encrypted session via key exchange.

27. The system of claim 15, wherein the location is an Internet link.

28. The system of claim 15, wherein the referral includes a MIME tag.
